(19) United States
(12) Patent Application Publication
(10) Pub. No.: US 2011/0221294 A1
(43) Pub. Date: Sep. 15, 2011

(54) BREATHER DEVICE AND DRIVE DEVICE

(75) Inventors: Isao Sato, Nagoya-shi (JP); Yuji Iwase, Mishima-shi (JP)

(73) Assignee: Toyota Jidosha Kabushiki Kaisha, Toyota-shi, Aichi (JP)

(21) Appl. No.: 13/130,443

(22) PCT Filed: Nov. 21, 2008
(86) PCT No.: PCT/JP2008/071216

§ 371 Date: May 20, 2011

(51) Int. Cl. H02K 5/22

(52) U.S. Cl. 310/89

(57) ABSTRACT

A breather device is provided at a housing case housing a rotating electric machine, for adjusting a pressure inside the housing case. The rotating electric machine includes a stator core formed by stacking a plurality of steel plates. The breather device communicates with an inside of the housing case by a gap between the steel plates.

### TECHNICAL FIELD

The present invention relates to a breather device and a drive device, and particularly to a breather device and a drive device that allow suppression of blowout of oil and oil mist.

### BACKGROUND ART

Various types of transmission units and the like for various types of hybrid vehicles have been conventionally proposed for the purpose of breather blowing, improving safety at the time of mounting on the vehicle, and the like.

For example, a transmission unit for a hybrid vehicle described in Japanese Patent Laying-Open No. 2001-260675 (Patent Document 1) includes a unit housing, and this unit housing is provided with a first dry chamber housing an electromagnetic clutch, a second dry chamber housing a motor, and a transmission mechanism unit.

A breather hole for keeping the pressure inside the second dry chamber constant is formed in the unit housing, and a breather pipe is pressed into the breather hole. This breather pipe allows the second dry chamber to communicate with the outside of the unit housing, and the breather pipe is made from a nonconductive material.

In this transmission unit, the breather pipe is made from the nonconductive material. Therefore, when the transmission unit hits an engine and the like at the time of mounting the transmission unit on the vehicle or when the transmission unit falls, the breather pipe may go into the transmission and come into contact with a high-voltage component within the second dry chamber due to impact caused by the hit or fall. The present invention aims at preventing a short circuit even in such a case.
Patent Document 1: Japanese Patent Laying-Open No. 2001-260675

### DISCLOSURE OF THE INVENTION

### Problems to be Solved by the Invention

The breather pipe of the above transmission unit is connected to a portion of an inner circumferential surface of the unit housing, which is located on the outer circumferential side of a coil end of a stator. Since there is a gap between the coil end and the inner circumferential surface of the unit housing, oil and oil mist in the unit housing are emitted outside through the gap and the breather pipe.

The present invention has been made in light of the problems as described above, and an object thereof is to provide a breather device and a drive device including the breather device that allow suppression of emission of oil, oil mist and the like.

### Means for Solving the Problems

A breather device according to the present invention is provided at a housing case housing a rotating electric machine, for adjusting a pressure inside the housing case. The rotating electric machine includes a stator core formed by stacking a plurality of steel plates. The breather device communicates with an inside of the housing case by a gap between the steel plates.

Preferably, the breather device is provided at the housing case more radially outward than the stator core and adjacent to an outer circumferential surface of the stator core.

Preferably, the breather device includes a breather chamber defined by an outer circumferential surface of the stator core and the housing case, and a valve body for switching a connection state between the breather chamber and an outside, of the housing case. A portion of an inner circumferential surface of the housing case, which is located around the breather chamber, is brought into close contact with the outer circumferential surface of the stator core. Preferably, the rotating electric machine includes a rotor positioned inside the stator core and provided to be rotatable about a rotation center line. The rotating electric machine is positioned above the rotation center line.

Preferably, the stator core includes a plurality of seats formed to project radially outward from an outer circumferential surface of the stator core and spaced apart from one another in a circumferential direction of the stator core. The rotating electric machine includes a fixing member inserted into a through hole formed in the seat, for fixing the stator core to the housing case. A portion of the outer circumferential surface of the stator core, which is located between the seats, and an inner circumferential surface of the housing case are in close contact with each other. The breather device is located on a radially outward side and adjacent to the portion of the outer circumferential surface of the stator core, which is located between the seats.

Preferably, the breather device is located on the radially outward side and adjacent to a portion of the outer circumferential surface of the stator core, which is located nearer a circumferential center between the seats than the seat or located at the circumferential center.

Preferably, the breather device is located on the radially outward side and adjacent to a portion of the outer circumferential surface of the stator core, which is located nearer the seat than a circumferential center between the seats.

Preferably, a drive device includes: the rotating electric machine; the housing case; and the breather device according to claim 1.

### Effects of the Invention

In the breather device and the drive device according to the present invention, blowout of oil and oil mist can be suppressed.

### BRIEF DESCRIPTION OF THE DRAWINGS

FIG. 1 is a schematic diagram showing a structure of a hybrid vehicle to which a drive device according to one embodiment of the present invention is applied.

FIG. 2 is a circuit diagram showing a structure of a main portion of a PCU that controls driving of a motor generator.

FIG. 3 is a cross-sectional view showing a structure of the motor generator and its surroundings.

FIG. 4 is a cross-sectional view taken along line IV-IV in FIG. 3.

FIG. 5 is a cross-sectional view showing a modification of a position where a breather device is mounted.

### DESCRIPTION OF THE REFERENCE SIGNS

100 engine; 110 crankshaft; 200 drive device; 211, 221 rotor; 212, 222 stator; 222A stator core; 222B stator coil; 222C fastening member; 223 stator teeth; 224 yoke portion; 225 electromagnetic steel plate; 227 seat; 230 hollow rotation shaft; 231 oil pump driving shaft; 240 oil pump; 600 casing; 610 housing chamber; 611 housing chamber; 612 housing chamber; 700 breather device; 701 breather chamber; 702 breather pipe; 703 valve body; O rotation center line; P1 circumferential center

### BEST MODES FOR CARRYING OUT THE INVENTION

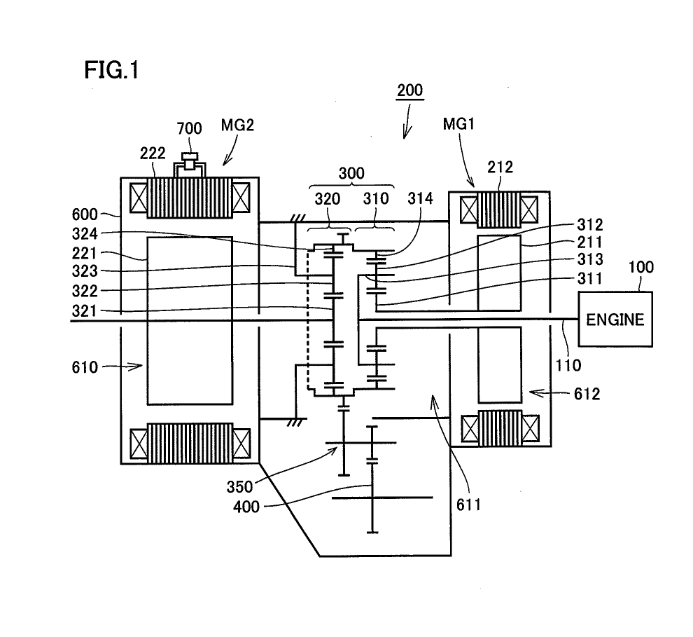

A breather device 700 and a drive device 200 according to a first embodiment of the present invention will be described with reference to FIGS. 1 to 5. It is to be noted that any reference to the number, amount or the like in the embodiments as will be described below is not necessarily intended to limit the scope of the present invention to that number, amount or the like, unless otherwise specified. In addition, each component in the following embodiments is not necessarily essential to the present invention, unless otherwise specified.

FIG. 1 is a schematic diagram showing a structure of a hybrid vehicle to which a drive device according to one embodiment of the present invention is applied.

Referring to FIG. 1, the hybrid vehicle includes drive device 200 for rotating a driving wheel, and drive device 200 includes an engine 100, motor generators MG1 and MG2, a power split device 300, a differential mechanism 400, and a casing 600. A housing chamber 610 housing motor generator MG2, a housing chamber 611 housing power split device 300, and a housing chamber 612 housing motor generator MG1 are formed within casing 600. Housing chamber 610 is provided with breather device 700 for adjusting the pressure inside housing chamber 610 and making the pressure inside housing chamber 610 equal to the pressure outside housing chamber 610. It is to be noted that housing chamber 610 communicates with housing chamber 611 and housing chamber 612, and the pressure inside housing chamber 611 and housing chamber 612 is also adjusted by adjusting the pressure inside housing chamber 610.

Motor generators MG1 and MG2 are formed to include rotors 211 and 221 and stators 212 and 222, respectively.

Further, power split device 300 is formed to include planetary gears 310 and 320. Planetary gears 310 and 320 are formed to include sun gears 311 and 321, pinion gears 312 and 322, planetary carriers 313 and 323, and ring gears 314 and 324, respectively.

A crankshaft 110 of engine 100 and rotors 211 and 221 of motor generators MG1 and MG2 rotate about the same axis.

Sun gear 311 of planetary gear 310 is coupled to a hollow sun gear shaft, through the center of which crankshaft 110 passes. Ring gear 314 is rotatably supported, coaxially with crankshaft 110. Pinion gear 312 is positioned between sun gear 311 and ring gear 314, and it revolves on an outer circumference of sun gear 311 while it rotates. Planetary carrier 313 is coupled to an end of crankshaft 110, and supports a rotation shaft of each pinion gear 312.

A counter drive gear for taking out power from power split device 300 rotates integrally with ring gear 314. The counter drive gear is connected to a counter gear 350. Power is transmitted to/from the counter drive gear and counter gear 350. Counter gear 350 drives differential mechanism 400. On a downhill, for example, rotations of wheels are transmitted to differential mechanism 400, and counter gear 350 is driven by differential mechanism 400.

Motor generator MG1 mainly operates as a generator that generates electromotive force across opposite ends of a three-phase coil by the interaction between rotation of rotor 211 and magnetic field of permanent magnets.

Rotor 221 of motor generator MG2 is coupled to a ring gear case that rotates integrally with ring gear 314 of planetary gear 310, through planetary gear 320 as a reduction gear.

Motor generator MG2 operates as an electric motor that rotates and drives rotor 221 by the interaction between the magnetic field generated by permanent magnets embedded in rotor 221 and the magnetic field formed by a three-phase coil wound around stator 222. Further, motor generator MG2 also operates as a generator that generates electromotive force across opposite ends of the three-phase coil by the interaction between the magnetic field generated by permanent magnets and the rotation of rotor 221.

Planetary gear 320 realizes speed reduction by the structure in which planetary carrier 323 as one of the rotating elements is fixed on a case of the vehicle drive device. Specifically, planetary gear 320 includes a sun gear 321 coupled to the shaft of rotor 221, a ring gear 324 that rotates integrally with ring gear 314, and a pinion gear 322 that meshes with ring gear 324 and sun gear 321 and transmits rotation of sun gear 321 to ring gear 324.

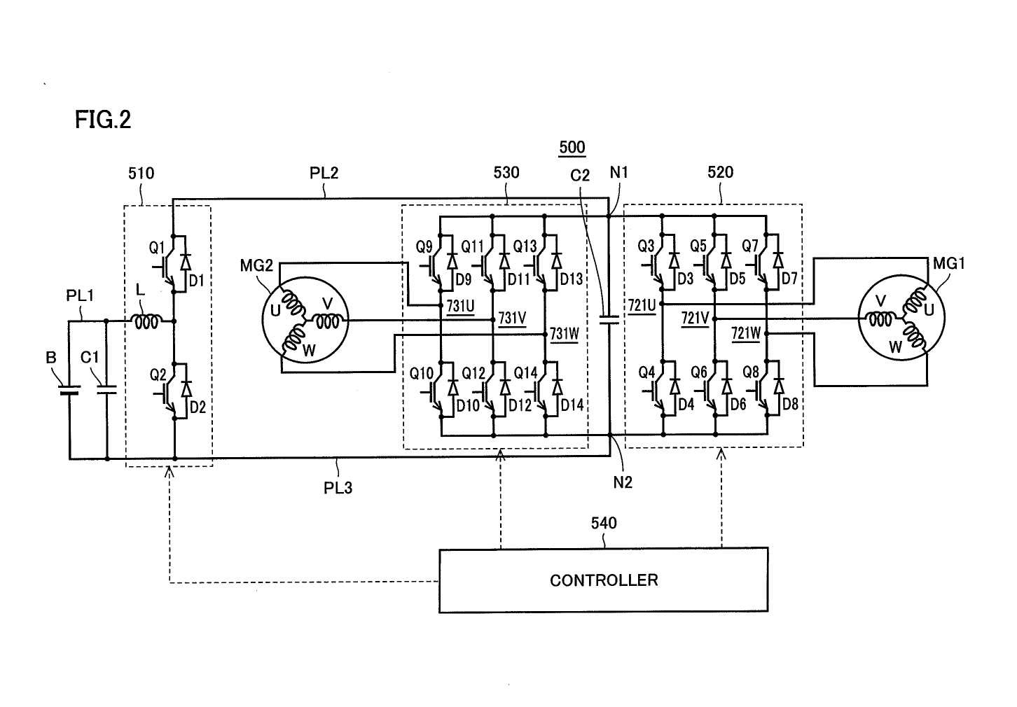

FIG. 2 is a circuit diagram showing a structure of a main portion of a PCU 500 that controls driving of motor generators MG1 and MG2. Referring to FIG. 2, PCU 500 is formed to include a converter 510, inverters 520 and 530, a controller 540, a filter capacitor C1, and a smoothing capacitor C2. Converter 510 is connected between a battery B and inverters 520 and 530, and inverters 520 and 530 are connected to motor generators MG1 and MG2, respectively.

Converter 510 includes power transistors Q1 and Q2, diodes D1 and D2, and a reactor L. Power transistors Q1 and Q2 are connected in series, and each at its base, receive a control signal from controller 540. Diodes D1 and D2 are connected between a collector and an emitter of power transistors Q1 and Q2, respectively, to cause current flow from the emitter side to the collector side of power transistors Q1 and Q2, respectively. Reactor L has one end connected to a power supply line PL1 connected to a positive electrode of battery B, and the other end connected to a connection node between power transistors Q1 and Q2.

Converter 510 boosts DC voltage received from battery B using reactor L, and supplies the boosted voltage to a power supply line PL2. Further, converter 510 lowers the DC voltage received from inverters 520 and 530, and with this voltage, charges battery B.

Inverters 520 and 530 include U-phase arms 521U and 531U, V-phase arms 521V and 531V, and W-phase arms 521W and 531W, respectively. U-phase arm 521U, V-phase arm 521V and W-phase arm 521W are connected in parallel between nodes N1 and N2. Similarly, U-phase arm 531U, V-phase arm 531V and W-phase arm 531W are connected in parallel between nodes N1 and N2.

U-phase arm 521U includes series-connected two power transistors Q3 and Q4. Similarly, U-phase arm 531U, V-phase arms 521V and 531V and W-phase arms 521W and 531W include series-connected two power transistors Q5 to Q14, respectively. Between a collector and an emitter of each of power transistors Q3 to Q14, diodes D3 to D14, causing current flow from the emitter side to the collector side, are connected, respectively.

A middle point of the arm of each phase in inverters 520 and 530 is connected to an end of each phase of coils of respective phases in motor generators MG1 and MG2. Motor generators MG1 and MG2 are formed by three coils of U, V and W phases, each having one end connected commonly to a midpoint.

Filter capacitor C1 is connected between power supply lines PL1 and PL3, and smoothes voltage level of power supply line PL1. Further, smoothing capacitor C2 is connected between power supply lines PL2 and PL3, and smoothes voltage level of power supply line PL2.

Inverters 520 and 530 convert a DC voltage from smoothing capacitor C2 to an AC voltage based on a drive signal from controller 540, and thereby drive motor generators MG1 and MG2.

Controller 540 calculates coil voltages of respective phases of motor generators MG1 and MG2, based on a motor torque command value, phase current values of motor generators MG1 and MG2, and input voltages of inverters 520 and 530, and based on the result of calculation, generates and outputs to inverters 520 and 530 a PWM (Pulse Width Modulation) signal for turning on/off power transistors Q3 to Q14.

Further, controller 540 calculates duty ratio of power transistors Q1 and Q2 for optimizing input voltages of inverters 520 and 530 based on the above motor torque command value and the motor rotation number, and based on the result of calculation, generates and outputs to converter 510 a PWM signal for turning on/off power transistors Q1 and Q2.

Further, controller 540 controls switching operations of power transistors Q1 to Q14 of converter 510 and inverters 520 and 530, in order to convert the AC power generated by motor generators MG1 and MG2 to DC power and thereby to charge battery B.

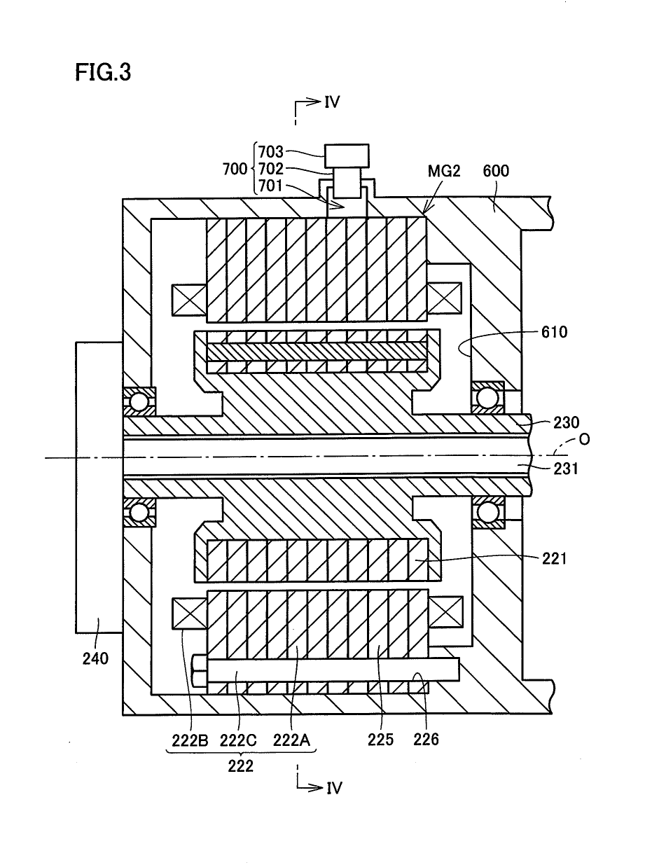

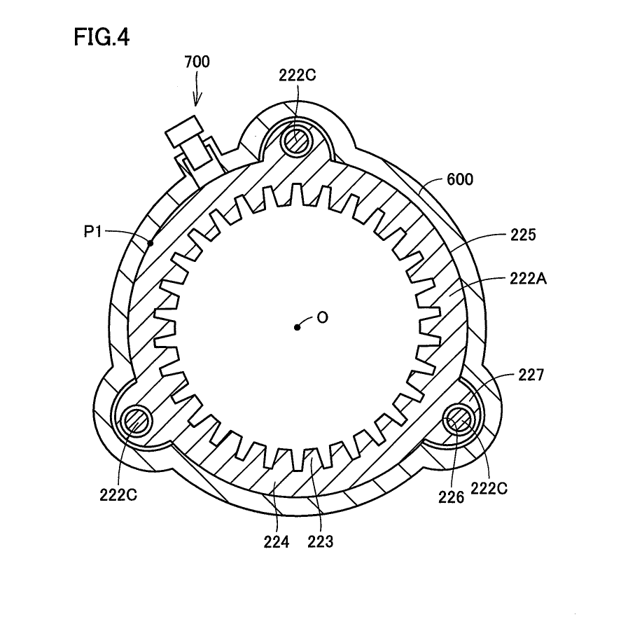

FIG. 3 is a cross-sectional view showing a structure of motor generator MG2 and its surroundings. FIG. 4 is a cross-sectional view taken along line Iv-Iv in FIG. 3. As shown in FIG. 3, motor generator MG2 includes stator 222 formed annularly and rotor 221 provided to be rotatable about a rotation center line O.

Stator 222 includes a stator core 222A formed annularly, a stator coil 222B attached to stator core 222A, and a fastening member (fixing member) 222C such as a bolt for fixing stator core 222A to casing 600.

Stator core 222A is formed of stacked steel plates formed by stacking a plurality of electromagnetic steel plates 225. As shown in FIG. 4, stator core 222A includes a yoke portion 224 formed annularly and a plurality of stator teeth 223 projecting radially inward from an inner circumferential surface of yoke portion 224. Stator coil 222B is attached to stator teeth 223.

In FIG. 3, rotor 221 is inserted into stator core 222A and rotor 221 includes a hollow rotation shaft 230 having opposing ends supported by casing 600. It is to be noted that an oil pump driving shaft 231 is inserted into this hollow rotation shaft 230 and this oil pump driving shaft 231 receives power from engine 100 through crankshaft 110. Oil pump driving shaft 231 drives an oil pump 240 to supply oil to a bearing or to spray oil to a coil end of stator coil 222B.

Breather device 700 is provided at a portion of casing 600 located on the outer circumferential side of stator core 222A. Breather device 700 communicates with the inside of housing chamber 610 by a gap between electromagnetic steel plates 225. When the pressure inside housing chamber 610 increases, air in housing chamber 610 travels from an inner circumferential surface of stator core 222A through the gap between electromagnetic steel plates 225 to breather device 700 and is discharged outside.

While the air in housing chamber 610 passes between electromagnetic steel plates 225, oil and oil mist contained in the air adhere to electromagnetic steel plates 225. Then, the air in housing chamber 610 having the oil and oil mist removed therefrom reaches breather device 700.

As a result, blowout of the oil and oil mist to the outside of casing 600 when the air is discharged outside from breather device 700 is suppressed.

Breather device 700 includes a breather chamber 701 formed to be open to housing chamber 610, a breather pipe 702 inserted into this breather chamber 701, and a valve body 703 capable of switching the communication state between housing chamber 610 and the outside through breather pipe 702.

An opening of breather chamber 701 open to housing chamber 610 is blocked by an outer circumferential surface of the stacked steel plates of stator core 222A. Furthermore, an inner circumferential surface of casing 600 located around the opening of breather chamber 701 and the outer circumferential surface of stator core 222A are in close contact with each other.

Therefore, ingress of the air and the oil in housing chamber 610 from between an opening edge of breather chamber 701 and the outer circumferential surface of stator core 222A to breather chamber 701 can be suppressed. As a result, the air in housing chamber 610 passes between electromagnetic steel plates 225 of stator core 222A blocking the opening of breather chamber 701 and reaches breather chamber 701. The oil and oil mist are removed from the air while the air passes between electromagnetic steel plates 225 as described above, and blowout of the oil and oil mist from breather device 700 can be suppressed.

As shown in FIG. 4, a plurality of seats 227 are circumferentially spaced apart from one another and formed on the outer circumferential surface of stator core 222A.

Each seat 227 projects radially outward from an outer circumferential surface of yoke portion 224 and a through hole 226 extending in the direction of rotation center line O is formed in seat 227. Fastening member 222C is inserted into each through hole 226 to fix stator core 222A to casing 600.

Here, a gap is provided between each seat 227 and the inner circumferential surface of casing 600. On the other hand, a portion of the outer circumferential surface of stator core 222A, which is located between seats 227, and the inner circumferential surface of casing 600 are in close contact with each other substantially without any gap.

Breather device 700 is provided on the radially outward side and adjacent to the portion of the outer circumferential surface of stator core 222A, which is located between seats 227. Therefore, around breather device 700, the outer circumferential surface of stator core 222A and the inner circumferential surface of casing 600 are in close contact with each other. Therefore, ingress of the oil to between the outer circumferential surface of stator core 222A and the inner circumferential surface of casing 600 and arrival of this oil at breather device 700 are suppressed.

Fastening member 222C presses each electromagnetic steel plate 225 against an inner wall surface of casing 600, and the surface pressure between respective electromagnetic steel plates 225 around fastening member 222C is higher than the surface pressure between electromagnetic steel plates 225 in the other region.

Breather device 700 is provided on the radially outward side and adjacent to a portion of the outer circumferential surface of stator core 222A, which is located closer to seat 227 than a circumferential center P1 between seats 227.

Therefore, a portion of stator core 222A, which is located radially inward and adjacent to breather device 700, has a high surface pressure between electromagnetic steel plates 225 and has a narrow gap between electromagnetic steel plates 225.

As a result, the efficiency of removing the oil and oil mist contained in the air while the air in housing chamber 610 passes between electromagnetic steel plates 225 and reaches breather device 700 can be improved.

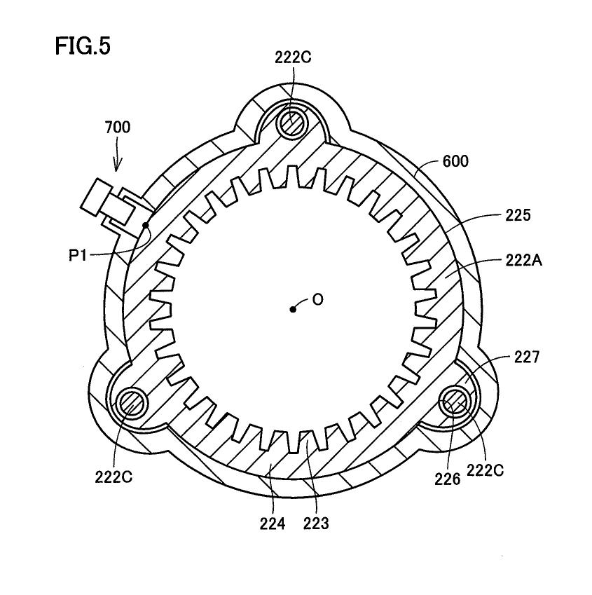

It is to be noted that the position where breather device 700 is mounted is not limited to the position as described above. For example, FIG. 5 is a cross-sectional view showing a modification of the position where breather device 700 is mounted. In this example shown in FIG. 5, breather device 700 is provided more radially outward than circumferential center P1 and adjacent to a portion of the outer circumferential surface of stator coil 222B, which is located on the circumferential center P1 side between seats 227.

Since a portion of stator core 222A located at and around circumferential center P1 is apart from seat 227 in the circumferential direction, the surface pressure between electromagnetic steel plates 225 is low. Therefore, the spacing of the gap between electromagnetic steel plates 225 at and around circumferential center P1 is larger than the spacing of the gap in the other portion.

Breather device 700 is provided at the portion located adjacent to circumferential center P1 and more radially outward than circumferential center P1. Therefore, the air in housing chamber 610 passes through the portion of stator core 222A having a wide gap between electromagnetic steel plates 225 and reaches breather device 700. In this manner, the air discharged from breather device 700 passes through the region having the wide gap between electromagnetic steel plates 225, and thus, the resistance of the air during flowing from housing chamber 610 to breather device 700 is suppressed to low level. Therefore, even if the pressure inside housing chamber 610 increases sharply, for example, the air in housing chamber 610 can be excellently discharged outside from breather device 700 and the pressure inside housing chamber 610 can become equal to or approximated to the external pressure in a short time.

Although breather device 700 is located more radially outward than circumferential center P1 and adjacent to circumferential center P1 in this example shown in FIG. 5, the position where breather device 700 is positioned is not limited to the above position.

For example, breather device 700 may be positioned adjacent to a portion of the outer circumferential surface of stator core 222A located between seats 227, which is located nearer circumferential center P1 than seat 227, and more radially outward than the portion.

In housing chamber 610, the oil is supplied to the bearing to attain lubrication of the bearing or the oil is sprayed to the coil end to cool the coil end. Therefore, the oil accumulates at the bottom of housing chamber 610.

Breather device 700 is provided above rotation center line O, and thus, arrival of the liquid level of the oil accumulating at the bottom of housing chamber 610 at a position above breather device 700 is suppressed. As a result, the oil that has accumulated at the bottom of housing chamber 610 never reaches breather device 700 through the gap between electromagnetic steel plates 225, and discharge of the oil that has accumulated at the bottom of housing chamber 610 from breather device 700 to the outside is suppressed.

As described above, breather device 700 according to the present embodiment includes the recess formed in the inner circumferential surface of casing 600, and the valve body capable of switching the communication state between the inside of this recess and the outside. The opening of the recess open to housing chamber 610 is blocked by the outer circumferential surface of the stator core formed by stacking a plurality of electromagnetic steel plates.

As described above, the structure of breather device 700 itself is simple, and further, the volume occupied by breather device 700 itself is also suppressed to be small. Therefore, an increase in the volume of drive device 200 caused by providing breather device 700 is suppressed.

Although stator core 222A of motor generator MG1 according to the present embodiment is configured by staking the annular electromagnetic steel plates, other structures can also be employed as the structure of stator core 222A.

A description will now be given of the case where stator core 222A is configured by a split stator core positioned annularly in the circumferential direction, and a fixing ring provided around an outer circumference of this split stator core.

In this case, each split stator core is formed by stacking a plurality of electromagnetic steel plates and tying the respective electromagnetic steel plates together. A method for tying the plurality of electromagnetic steel plates together includes, for example, a method for tying electromagnetic steel plates together by forming a protrusion and a depression on/in each electromagnetic steel plate and inserting a protrusion of an electromagnetic steel plate into a depression of an adjacent electromagnetic steel plate. This method is generally called “caulking.” The fixing ring is shrink fitted or press fitted on the outer circumferential side of the plurality of split stator cores arranged annularly. This fixing ring presses each split stator core radially inward. As a result, the split stator cores that are adjacent in the circumferential direction press each other due to the pressing force from the fixing ring and the respective split stator cores are fixed with they arranged annularly. A through hole is formed in a portion of this fixing ring, which is located adjacent to breather device 700 and radially inward with respect to breather device 700.

In the case as well where stator core 222A configured by such split stator cores is employed, the air in housing chamber 610 passes through the gap between the electromagnetic steel plates and the through hole formed in the fixing ring and reaches breather device 700 when the pressure inside housing chamber 610 increases. Therefore, oil mist adheres to the electromagnetic steel plates of the split stator cores by the time the air in housing chamber 610 reaches breather device 700, and emission of the oil mist to the outside can be suppressed.

Although the embodiments of the present invention have been described, it should be understood that the embodiments disclosed herein are illustrative and not limitative in any respect. The scope of the present invention is defined by the terms of the claims, and is intended to include any modifications within the scope and meaning equivalent to the terms of the claims.

### INDUSTRIAL APPLICABILITY

The present invention is applicable to a breather device and a drive device, and is suitable for a breather device and a drive device that suppress blowout of oil and oil mist.

1. A breather device provided at a housing case housing a rotating electric machine, for adjusting a pressure inside said housing case,
said rotating electric machine including a stator core formed by stacking a plurality of steel plates,
said breather device including an opening open to said housing case,
said opening being blocked by an outer circumferential surface of stacked steel plates formed by stacking said plurality of steel plates, and
said breather device communicating with an inside of said housing case by a gap between said steel plates.

2. The breather device according to claim 1, wherein
said breather device is provided at a portion of said housing case located more radially outward than said stator core and adjacent to an outer circumferential surface of said stator core.

3. The breather device according to claim 1, wherein
said breather device includes a breather chamber defined by an outer circumferential surface of said stator core and said housing case, and a valve body for switching a connection state between said breather chamber and an outside, and
a portion of an inner circumferential surface of said housing case, which is located around said breather chamber, is brought into close contact with the outer circumferential surface of said stator core.

4. The breather device according to claim 1, wherein
said rotating electric machine includes a rotor positioned inside said stator core and provided to be rotatable about a rotation center line, and
said breather device is positioned above said rotation center line.

5. The breather device according to claim 1, wherein
said stator core includes a plurality of seats formed to project radially outward from an outer circumferential surface of the stator core and spaced apart from one another in a circumferential direction of said stator core,
said rotating electric machine includes a fixing member inserted into a through hole formed in said seat, for fixing said stator core to said housing case,
a portion of the outer circumferential surface of said stator core, which is located between said seats, and an inner circumferential surface of said housing case are in close contact with each other, and
said breather device is located on a radially outward side and adjacent to the portion of the outer circumferential surface of said stator core, which is located between said seats.

6. The breather device according to claim 5, wherein
said breather device is located on the radially outward side and adjacent to a portion of the outer circumferential surface of said stator core, which is located nearer a circumferential center between said seats than said seat or located at said circumferential center.

7. The breather device according to claim 5, wherein
said breather device is located on the radially outward side and adjacent to a portion of the outer circumferential surface of said stator core, which is located nearer said seat than a circumferential center between said seats.

8. A drive device, comprising:
said rotating electric machine;
said housing case; and
the breather device according to claim 1.
